(19) United States
(12) Patent Application Publication
(10) Pub. No.: US 2025/0040621 A1
(43) Pub. Date: Feb. 6, 2025

(54) AEROSOL PROVISION DEVICE COMPRISING A RADIO FREQUENCY RECEIVER FOR POWER HARVESTING

(71) Applicant: NICOVENTURES TRADING LIMITED, London (GB)

(72) Inventors: Mohammed AL-AMIN, London (GB); Connor BRUTON, London (GB); Damyn MUSGRAVE, London (GB)

(21) Appl. No.: 18/717,713

(22) PCT Filed: Dec. 8, 2022
(86) PCT No.: PCT/GB2022/053139

§ 371 Date: Jun. 7, 2024

(30) Foreign Application Priority Data
Dec. 9, 2021 (GB) 2117822.3

(51) Int. Cl. A24F 40/65; A24F 40/10; A24F 40/50; A24F 40/90; H04B 5/79

(52) U.S. Cl. CPC A24F 40/65; A24F 40/10; A24F 40/50; A24F 40/90; H04B 5/79

(57) ABSTRACT

A method comprising: receiving radio frequency signals using an antenna; extracting (e.g. using a power module) electrical power from the received radio frequency signals; and controlling (e.g. using a control module)) use of the extracted electrical power by a vaporiser of the aerosol provision device.

### TECHNICAL FIELD

The present specification relates to the control of use of extracted electrical power; for example by an aerosol provision device.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol provision substrate such as tobacco to form an aerosol by heating, but not burning, the substrate. There remains a need for further developments in this field.

### SUMMARY

In a first aspect, this specification describes a device comprising: an antenna configured to receive radio frequency signals; a power module configured to extract electrical power from the received radio frequency signals; and a control module configured to control use of the extracted electrical power by a vaporiser of the aerosol provision device. The antenna may be configured to transmit and/or receive data. The device may further comprise said vaporiser.

The device may further comprise a reservoir. The reservoir may be configured to store a liquid or gel and the vaporiser is configured to vaporise the liquid or gel.

The vaporiser may be powered directly by the extracted electrical power under the control of the control module.

The device may further comprise a power storage device (e.g. a battery or a supercapacitor) for storing electrical power extracted from the received radio frequency signals by the power module. The vaporiser may be powered, at least in part, by the extracted electrical power stored in the power storage device. A capacity of the power storage device may be limited such that the power storage device is configured to store sufficient energy for a single use or puff of said aerosol provision device. The control module may be configured to control use of the extracted electrical power for charging the power storage device. The control module may be configured to simultaneously charge the power storage device and to provide electrical power to the vaporiser. The control module may be configured to preferentially provide electrical power to the vaporiser over charging the power storage device.

In a second aspect, this specification describes a method comprising: receiving radio frequency signals using an antenna; extracting electrical power from the received radio frequency signals; and controlling use of the extracted electrical power by a vaporiser of the aerosol provision device.

The method may further comprise vaporising a liquid or gel stored in a reservoir.

The method may further comprise powering the vaporiser directly by the extracted electrical power.

The method may further comprise storing electrical power extracted from the received radio frequency signals. The vaporiser may be powered, at least in part, by the extracted electrical power stored in the power storage device. The method may further comprise simultaneously storing electrical power and providing electrical power to the vaporiser. The method may further comprise preferentially providing electrical power to the vaporiser over charging the power storage device.

### BRIEF DESCRIPTION OF THE DRAWINGS

Example embodiments will now be described, by way of example only, with reference to the following schematic drawings, in which:

FIG. 1 is a block diagram of a non-combustible aerosol provision device in accordance with an example embodiment;

FIG. 2 is a block diagram of a system in accordance with an example embodiment;

FIG. 3 is a flow chart showing an algorithm in accordance with an example embodiment;

FIG. 4 is a block diagram of a system in accordance with an example embodiment; and

FIG. 5 is a flow chart showing an algorithm in accordance with an example embodiment.

### DETAILED DESCRIPTION

As used herein, the term “delivery system” is intended to encompass systems that deliver at least one substance to a user, and includes non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “combustible” aerosol provision system is one where a constituent aerosol-generating material of the aerosol provision system (or component thereof) is combusted or burned during use in order to facilitate delivery of at least one substance to a user.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In one embodiment, the active substance is a legally permissible recreational drug. In some embodiments, the active substance comprises nicotine. In some embodiments, the active substance comprises caffeine, melatonin or vitamin B12. In some embodiments, the active substance comprises or is derived from one or more botanicals or constituents, derivatives or extracts thereof and the botanical is tobacco. In some embodiments, the substance to be delivered comprises a flavour.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-generating material) or the retained fluid may be solvent (such as when the aerosol-generating material is formed from a slurry). In some embodiments, the solvent may be water.

In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The material may be present on or in a support, to form a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

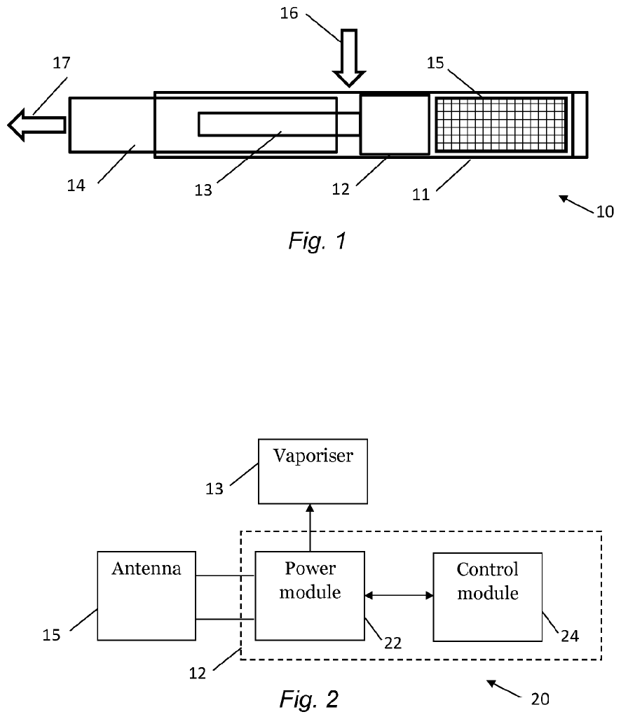

FIG. 1 is a block diagram of a non-combustible aerosol provision device, indicated generally by the reference numeral 10, in accordance with an example embodiment.

The aerosol provision device 10 comprises a control circuit 12, a heater 13 and a consumable 14 (e.g. a tobacco consumable, for example in the form of a tobacco stick). The device also includes an antenna 15. The example antenna 15 is shown provided near the base of the device; however, this is one of many example locations. As discussed in detail below, the antenna may be used to receive radio frequency signals for use in obtaining electrical power for use by the device (e.g. under the control of the control circuit 12). In addition, the antenna 15 may be used to transmit and/or receive data, for example using one of a number of protocols (e.g. Bluetooth, Wi-Fi etc.).

In the use of the device 10, the heater 13 is inserted into the consumable 14, such that the consumable may be heated to generate an aerosol (and tobacco flavour, in the case of a tobacco consumable) for the user. When a user inhales at the end of the consumable, as indicated by arrow 17, the air is drawn into the device 10, through an air inlet as indicated by arrow 16, then passes through the consumable, delivering the aerosol (and tobacco flavour, in the case of a tobacco consumable) to the user.

The device 10 may additionally include a battery (and a battery 11 is shown schematically in FIG. 1); however, as discussed further below, this is not essential in all example embodiments.

The aerosol provision device 10 is described by way of example only. Many alternative aerosol provision devices may be used in example implementations of the principles described here. For example, the device 10 may be replaced within a vaping device in which an aerosol generating material (e.g. a liquid or gel) is heated to generate the aerosol. The principles of the present disclosure are not limited to a particular type of aerosol provision device 10 (that is to say, the aerosol provision device 10 may be arranged to aerosolise a solid, liquid or other aerosol-generating material via any suitable electrically powered or controller aerosol generator, such as a heater, a vibrating mesh, a source of irradiation, an electrically controller pressurised cannister which may include an electrically operated release valve, etc.).

FIG. 2 is a block diagram of a system, indicated generally by the reference numeral 20, in accordance with an example embodiment.

The system 20 comprises the control circuit 12, the vaporiser/aerosol generator 13 (including a heater) and the antenna 15 of the aerosol provision device 10 described above. The control circuit 12 of the system 20 comprises a charging controller 22 and a control module 24.

In the use of the system 20, the antenna 15 receives radio frequency signals for use in extracting electrical power. The extracted electrical power may be for use in by the vaporizer 13 (e.g. under the control of the control circuit 12).

It should be noted that, in some example embodiments, the functionality of the control module 24 is implemented by the charging controller 22. Indeed, the control module 24 may be omitted from some example embodiments.

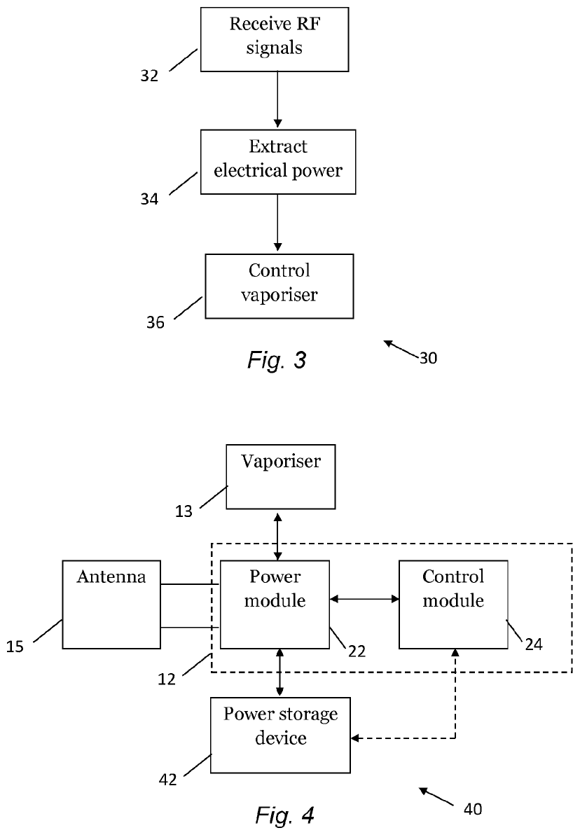

FIG. 3 is a flow chart showing an algorithm, indicated generally by the reference numeral 30, in accordance with an example embodiment. The algorithm 30 may be implemented using the system 20.

The algorithm 30 starts at operation 32, where radio frequency (RF) signals are received using an antenna (such as the antenna 15).

At operation 34, electrical power is extracted from the received radio frequency signals. The extraction of the electrical power may be performed by the power module 22 of the control circuit 12.

At operation 36, the use of the extracted electrical power by a vaporiser of the aerosol provision device is controlled (for example by the control module 24). For example, the vaporiser may be used to vaporise a liquid or gel stored in a reservoir, using energy extracted from the received radio frequency signals to do so.

FIG. 4 is a block diagram of a system, indicated generally by the reference numeral 40, in accordance with an example embodiment. The system 40 comprises the control circuit 12, the vaporiser 13 and the antenna 15 of the system 20 described above. The system 40 further comprises a power storage device 42 (such as a battery, e.g. the battery 11, or a supercapacitor). The power storage device may have a limited capacity. For example, the power storage device may be designed to provide sufficient energy for a single use or puff of said aerosol provision device or to provide sufficient energy for a small number (e.g. two or three) uses or puffs.

The antenna 15 may be used to receive radio frequency signals to extract electrical power for use by the vaporizer 13 (e.g. under the control of the control circuit 12). Furthermore, the power module 22 may be configured to charge the battery 11 with extracted electrical power (e.g. under the control of the control circuit 12), if the power storage device 42 is provided.

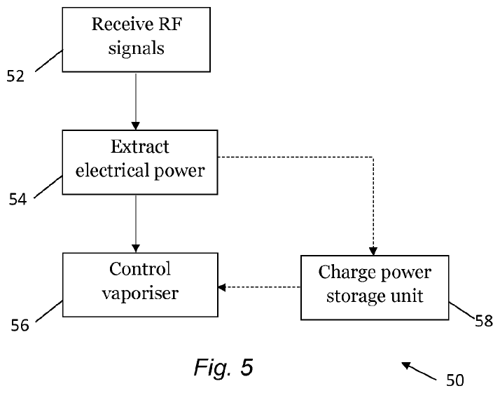

FIG. 5 is a flow chart showing an algorithm, indicated generally by the reference numeral 50, in accordance with an example embodiment. The algorithm 50 may be implemented by the system 40.

The algorithm 50 starts at operation 52, where radio frequency (RF) signals are received using an antenna (such as the antenna 15).

At operation 54, electrical power is extracted from the received radio frequency signals. The extraction of the electrical power may be performed by the power module 22 of the control circuit 12.

At operation 56, the use of the extracted electrical power by a vaporiser of the aerosol provision device is controlled (for example by the control module 24). For example, the vaporiser may be used to vaporise a liquid or gel stored in a reservoir, using energy extracted from the received radio frequency signals to do so.

In some example embodiments, the electrical power extracted in the operation 54 is used, in operation 58, to charge a power storage unit (e.g. the power storage device 42).

Thus, the system 40 may be configured to be able to power the vaporiser 13 directly by the extracted electrical power (e.g. omitting the operation 58). Alternatively, or in addition, the system 40 may be configured to be able to power the vaporiser 13, at least in part, with the extracted electrical power stored in the power storage device 42. As noted above, the power storage device may be limited, for example to provide sufficient energy for a single use or puff of said aerosol provision device.

The operations 56 and 58 may be carried out simultaneously. Thus, the power storage device may be charged (in the operation 58) and electrical power provided to the vaporiser (as part of the operation 56) simultaneously.

Moreover, whilst it may be possible to carry out the operations 56 and 58 simultaneously, in some example embodiments, providing electrical power to the vaporiser may be prioritised over charging the power storage device in at least some circumstances. Thus, extracted electrical power may be used to charge a power storage device/unit unless that extracted power is needed by the vaporiser.

As discussed above (for example with reference to the operations 34 and 54 of the algorithms 30 and 50), electrical power may be extracted from radio frequency (RF) signals. This may be implemented in a number of ways. For example, a receiving antenna may be provided to receive the RF signals, causing a potential difference to occur across the length of the antenna. Thus, an AC (typically sinusoidal) RF signal is obtained at the antenna. This AC signal is typically converted into a DC signal, for example using a rectifier circuit (such as a full bridge or half-bridge rectifier circuit). In some example embodiments, an impedance matching circuit is provided between the antenna and a rectifier circuit that seeks to maximise power transfer from the antenna to the rectifier. The DC electrical power output by the rectifier may, for example, be stored using a battery.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A device comprising:
an antenna configured to receive radio frequency signals;
a power module configured to extract electrical power from the received radio frequency signals; and
a control module configured to control use of the extracted electrical power by a vaporiser of the aerosol provision device.

2. A device as claimed in claim 1, further comprising a reservoir, wherein the reservoir is configured to store a liquid or gel and the vaporiser is configured to vaporise the liquid or gel.

3. A device as claimed in claim 1, wherein the vaporiser is powered directly by the extracted electrical power under the control of the control module.

4. A device as claimed in claim 1, further comprising a power storage device for storing electrical power extracted from the received radio frequency signals by the power module.

5. A device as claimed in claim 4, wherein the vaporiser is powered, at least in part, by the extracted electrical power stored in the power storage device.

6. A device as claimed in claim 4, wherein the power storage device is a battery or a supercapacitor.

7. A device as claimed in claim 4, wherein a capacity of the power storage device is limited such that the power storage device is configured to store sufficient energy for a single use or puff of said aerosol provision device.

8. A device as claimed in claim 4, wherein the control module is configured to control use of the extracted electrical power for charging the power storage device.

9. A device as claimed in claim 4, wherein the control module is configured to simultaneously charge the power storage device and to provide electrical power to the vaporiser.

10. A device as claimed in claim 4, wherein the control module is configured to preferentially provide electrical power to the vaporiser over charging the power storage device.

11. A device as claimed in claim 1, further comprising said vaporiser.

12. A device as claimed in claim 1, wherein the antenna is configured to transmit and/or receive data.

13. A method comprising:
receiving radio frequency signals using an antenna;
extracting electrical power from the received radio frequency signals; and
controlling use of the extracted electrical power by a vaporiser of the aerosol provision device.

14. A method as claimed in claim 13, further comprising vaporising a liquid or gel stored in a reservoir.

15. A method as claimed in claim 13, further comprising powering the vaporiser directly by the extracted electrical power.

16. A method as claimed in claim 13, further comprising storing electrical power extracted from the received radio frequency signals.

17. A method as claimed in claim 16, wherein the vaporiser is powered, at least in part, by the extracted electrical power stored in the power storage device.

18. A method as claimed in claim 16, further comprising simultaneously storing electrical power and providing electrical power to the vaporiser.

19. A method as claimed in claim 16, further comprising preferentially providing electrical power to the vaporiser over charging the power storage device.
